(19) United States
(12) Patent Application Publication
(10) Pub. No.: US 2015/0001283 A1
(43) Pub. Date: Jan. 1, 2015

(54) MAILBOX HAVING SOLAR POWER

(71) Applicant: Earthling, LLC, Roseville, MN (US)

(72) Inventors: Jefferson Ian Morris, Dellwood, MN (US); James Gregory Wohlford, Edina, MN (US); Michael Ming-Jae Lin, Pok Fu Lam (HK)

(21) Appl. No.: 14/315,568

(22) Filed: Jun. 26, 2014

Related U.S. Application Data
(60) Provisional application No. 61/840,778, filed on Jun. 28, 2013.

(51) Int. Cl. A47G 29/122; H02J 7/35; G07C 9/00

(52) U.S. Cl. CPC A47G 29/122; G07C 9/00015; H02J 7/35
USPC 232/17

(57) ABSTRACT

A mailbox has an interior cavity with an open front and a closed back opposite the open front. A hinged and moveable door covers the open front. An exterior surface is opposite the interior cavity and the exterior surface contains an exterior panel. The mailbox also contains a rechargeable battery. A solar panel is disposed on the mailbox and arranged to generate electrical energy for recharging the rechargeable battery. The solar panel is operatively connected to the rechargeable batter to form a circuit. A first light source is disposed within the interior cavity of the mailbox. The first light source is operatively connected to the rechargeable battery and is powered thereby. A photocell is disposed on an exterior panel of the mailbox and configured to block power to the first light source when the photocell is illuminated. Thus, the first light source only provides light when the photocell is not illuminated.

### FIELD OF THE INVENTION

The present invention relates to a mailbox, and in particular, a solar powered mailbox.

### BACKGROUND OF THE INVENTION

Many residential houses have a mailbox for collection of mail. Such mailboxes are frequently positioned roadside to provide convenient access for the mail carrier. In rural areas street lighting is often scarce or even nonexistent. Since it is common to retrieve mail at the end of the day, very often, and especially during times when the days are short such as late fall and winter, it is the case that people retrieve their mail after dark. This can be unsettling because with little or no light, one must check for mail by opening the mailbox door and using their hand to do a general sweep around the interior of the mailbox. Mailboxes usually also include a residence street address number which is frequently displayed with self-adhesive reflective numerals. Due to aging and weather, the numerals tend to deteriorate and must be replaced, and often times, when it is very dark, or if the numerals are worn, the address is not clearly visible.

U.S. Pat. No. 4,648,012 provides a lighting system for the interior of a mailbox. However, the lighting system uses disposable batteries which require periodic changing.

U.S. Pat. No. 6,033,084 also provides a lighting system for the interior of a mailbox which uses disposable batteries. Additionally, the mailbox must be formed from a ferromagnetic metallic material since a magnet is used to mount the lighting system to an inner surface of the mailbox.

U.S. Pat. No. 5,813,749 provides a solar powered mailbox internal light. The lighting system includes a solar panel, however, the panel is only for use in providing interior light, and is fixed to the mailbox thus it is not possible to adjust the panel for optimum sun exposure. Further, the lighting system requires a sensor for enabling electrical energy to the light only when the mailbox door is opened.

### SUMMARY OF THE INVENTION

The present invention provides a mailbox having an interior cavity with an open front and a closed back opposite the open front. A hinged and moveable door covers the open front. An exterior surface is opposite the interior cavity and the exterior surface contains an exterior panel. The mailbox also contains a rechargeable battery. A solar panel is disposed on the mailbox and arranged to generate electrical energy for recharging the rechargeable battery. The solar panel is operatively connected to the rechargeable battery to form a circuit. A first light source is disposed within the interior cavity of the mailbox. The first light source is operatively connected to the rechargeable battery and is powered thereby. A photocell is disposed on an exterior panel of the mailbox and configured to block power to the first light source when the photocell is illuminated. Thus, the first light source only provides light when the photocell is not illuminated.

Preferably, the solar panel is connected to the top portion of the mailbox to provide an integrated esthetic, and faces the sky.

Preferably, the solar panel is rotatably connected to the top portion of the mailbox so that a user may selectively position the solar panel. Preferably, the mailbox includes a lock to secure the door in a closed position.

In one embodiment the lock includes a keypad powered by the rechargeable battery. Alternatively, the lock is powered by a separate, replaceable battery.

In another embodiment the lock includes an electronic lock powered by the rechargeable battery or a separate replaceable battery and controlled by a key fob that is powered by a separate replaceable battery.

In another embodiment the lock includes near field communication (NFC).

Preferably, the mailbox includes an identification panel, the panel being illuminated by the first light source.

Preferably the identification panel is integral with the mailbox and the first light source provides backlighting to the panel.

In one embodiment the mailbox includes at least one accessory power socket in connected relation to the rechargeable battery for powering additional add-on electric accessories. Such an accessory power socket may be useful for powering additional lights, such as foot path lights, holiday lights, etc. without having to run a separate electric line out to the mailbox.

Without intending to be limited by theory, it is believed that the mailbox herein provides one or more advantages such as improved lighting, improved battery management, improved recharging, improved security, improved lighted house numbers, improved area lighting, and/or an improved mail retrieval experience. The mailbox herein may also simultaneously provide lighting to the inside of the mailbox and to the outside of the mailbox.

### BRIEF DESCRIPTION OF THE DRAWINGS

Preferred embodiments of the present invention will now be described, by way of example only, with reference to the accompanying drawings wherein:

FIG. 1 illustrates an embodiment of a mailbox having a solar panel;

FIG. 2 illustrates an embodiment of a mailbox having a solar panel;

FIG. 3 illustrates an embodiment of a mailbox having a solar panel;

FIG. 4 illustrates an embodiment of a mailbox having a solar panel;

FIG. 5 illustrates a top perspective view of the mailbox of FIG. 4;

FIG. 6 illustrates a partial view of the mailbox of FIG. 4;

FIG. 7 illustrates an embodiment of a mailbox having a lock and a back-lit address panel;

FIG. 8 illustrates another embodiment of a mailbox having architectural down lighting; and

FIG. 9 illustrates an embodiment of a mailbox having a lock.

The figures herein are for illustrative purposes only, and not necessarily drawn to scale.

### DESCRIPTION OF THE INVENTION

There is disclosed herein a mailbox 10 having means to provide solar power. The mailbox 10 may be formed from, for example, metal, aluminum, steel, plastic, another suitable material and a combination thereof; or from cast aluminum, stainless steel, plastic and a combination thereof.

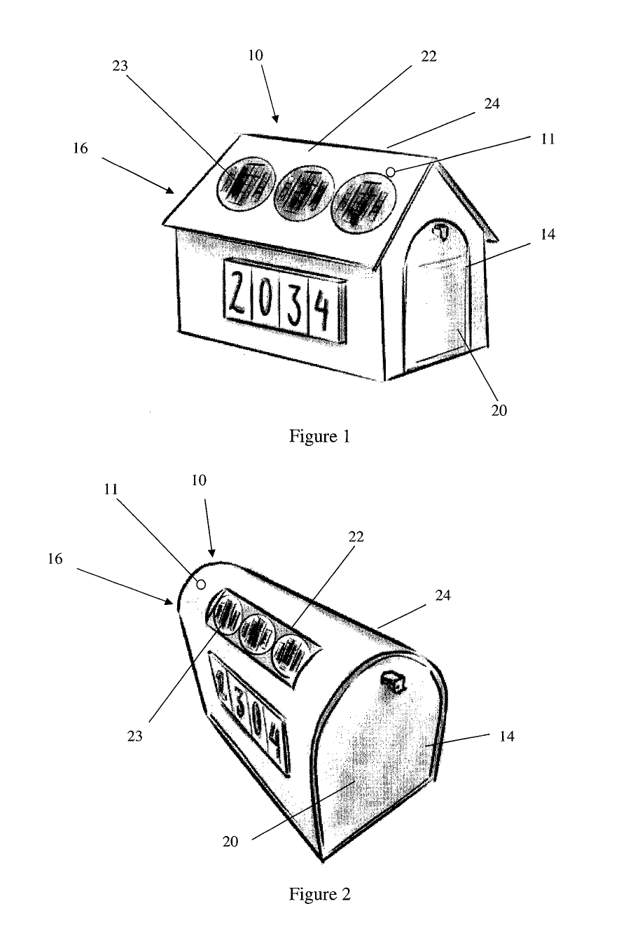

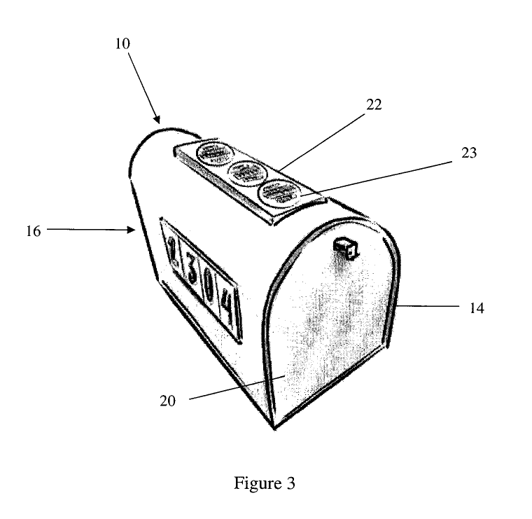

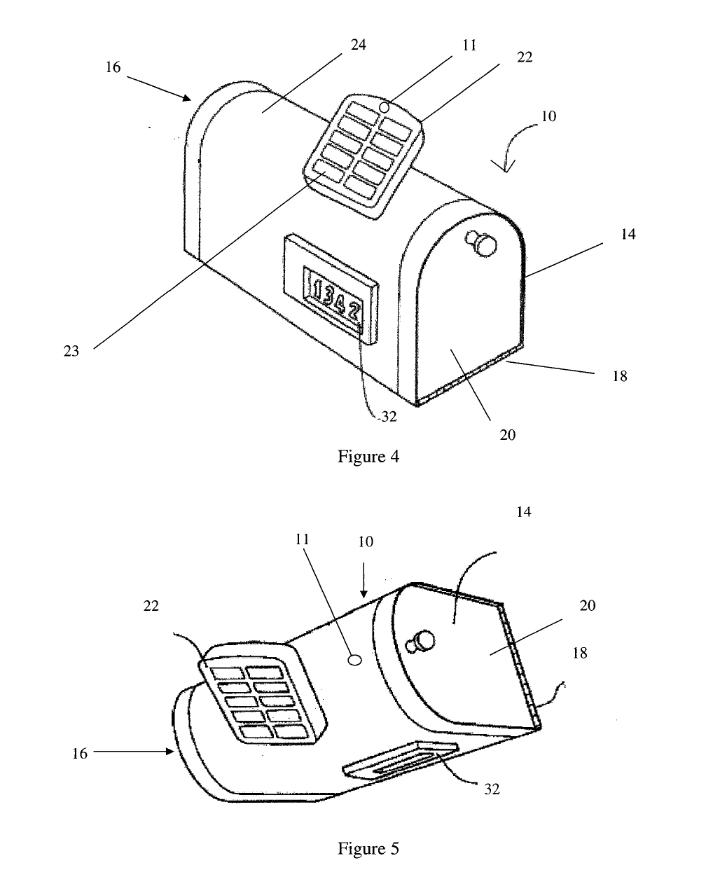

FIGS. 1 to 3 illustrate the exterior surface of a mailbox 10 having a solar panel. The mailbox 10 has an open front 14 and a closed back 16 which define the interior cavity (not shown) therebetween. The exterior surface is opposite the interior cavity. A hinged (see FIG. 4) 18 door 20 covers the open front 14. The mailbox 10 may have a peaked top portion 24 as shown in FIG. 1. Alternatively, the mailbox 10 may include a rounded top portion 24 as shown in FIG. 2. Both styles of mailbox are appropriate for solar power. At least one solar panel 22 is disposed on a top portion 24 of the mailbox 10. The solar panel 22 may be integral with the mailbox 10 as shown in FIGS. 1 and 2 or, alternatively, the solar panel 22 may be a separate part and attached to the mailbox 10 as shown in FIG. 3. The solar panel contains at least one solar cell 23; or a plurality of solar cells 23.

The solar panel 22 is arranged to generate electrical energy for recharging a rechargeable battery (not shown). The rechargeable battery may be arranged in any convenient position within a protected compartment (not shown) in the mailbox 10, such as in the interior cavity of the mailbox.

A first light source, in the form of a light emitting diode (LED), electroluminescent panel (not shown), or other similar low-energy lighting technology may be disposed within the mailbox 10. It is envisioned that at least one LED or electroluminescent panel is attached within the mailbox 10. In an embodiment herein the first light source contains a plurality of individual light sources therein. For example, a cluster of individual LEDs, or a cluster of individual electroluminescent panels. An electroluminescent panel is formed of a material, typically a doped semiconducting material, which emits photons by either having an electric current passed therethrough, or by being in close proximity to an electric current (i.e., induced electroluminescence).

Accordingly in an embodiment herein it the first light source provides less than 1200 lumens; or from about 1 lumens to about 1200 lumens; or from about 3 lumens to about 1000 lumens, or from about 7 lumens to about 500 lumens, or from about 10 lumens to about 250 lumens. This lumen output is typically rated and described in the specifications for the first light source.

The first light source may also be rated according to the lux, and in such a case, in an embodiment of the invention the lux is less than 13,000 lux; or from about 1 lux to about 13,000 lux; or from about 5 lux to about 11,000 lux, or from about 10 lux to about 5,400 lux, or from about 15 lux to about 2,700 lux, as measured using a standard lux meter at the door, 20, when it is open.

Currently, it has been found that an LED up to about 10 watts provides adequate lighting within the mailbox 10, but it is envisaged that as technology progresses, the first light source may require less and less wattage to provide an equivalent amount of light. Alternatively, it may be desirable to have more than one LEDs with a lower wattage. Such lower wattage LEDs are often positioned together to form a LED cluster. In an embodiment herein the LED uses about 0.5 watts. In an embodiment herein, the LED or LED cluster herein provides a cumulative power of at least about 5 watts, or from about 5 watts to about 80 watts, or from about 6 watts to about 50 watts, or from about 7 watts to about 40 watts.

A second light source, one or more light sources, and/or any other light sources in, on, or for the mailbox herein may also provide the lumens and/or lux described above, and/or may also draw the wattage described above.

The LED is powered by the rechargeable battery. In an embodiment herein, the solar panel, first light source, and the rechargeable battery are inter-coordinated such that the solar panel is of sufficient power that on a day with average sunshine, the solar panel will typically recharge the rechargeable battery sufficiently such that the first light source may remain continuously illuminated for at least about 8 hours; or from about 8 to about 16 hours; or from about 9 hours to about 12 hours. In an embodiment herein, the rechargeable battery consists of a plurality of rechargeable batteries and/or may contain a battery pack which contains a plurality of actual electrochemical cells therein.

A photocell 11 may be arranged on an external portion of the mailbox 10, or may even be arranged on the solar panel as in FIG. 4. The photocell may be configured to block power to the LED when the photocell is illuminated, for example, when sunlight hits the photocell. Such a feature conserves energy so that the first light source does not draw power when the first light source is not needed. Thus, the first light source only provides light when the photocell is not illuminated—i.e., when it is dark outside. The photocell is located on the exterior panel of the mailbox, preferably positioned in an area on the mailbox 10 where it is likely to receive sufficient sunlight. In an embodiment herein the photocell is located on an upper surface of the outside of the mailbox, such as the top portion, 24 which may coincide with an exterior panel. Without intending to be limited by theory it is believed that such a location on the top portion is advantageous as it allows ambient light to activate the photocell while reducing the occurrence of incidental and/or intermittent light sources such as car headlights, house lights, etc.

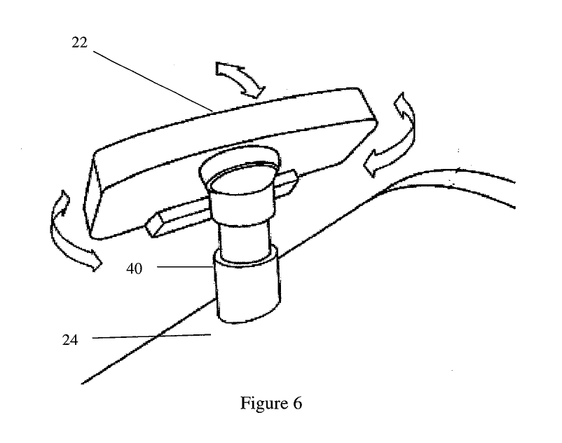

As shown in FIGS. 4-6, the solar panel 22 may be rotatably connected to the top portion 24 of the mailbox 10. A flexible connection 40 allows the user to selectively position the solar panel 22. This allows the user to customize the alignment of the solar panel to point directly toward the sun to ensure optimum energy generation. As used herein, the term “rotatably” indicates that the solar panel may rotate in one or more of the X, Y and Z axes. The flexible connection 40 may be attached to the mailbox using fasteners, welds or any other suitable attachment method. In an embodiment herein, the flexible connection is not easily removable from the outside of the mailbox.

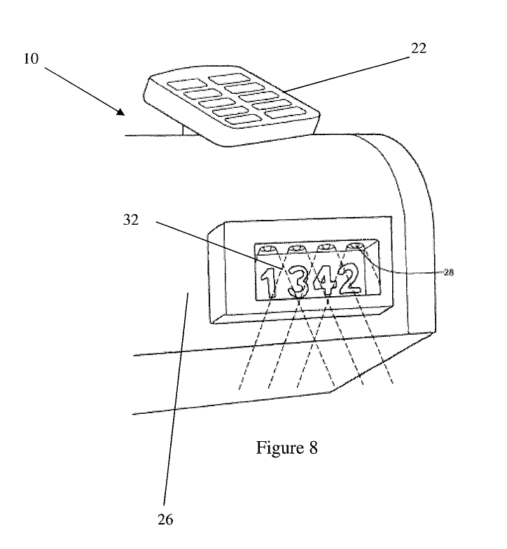

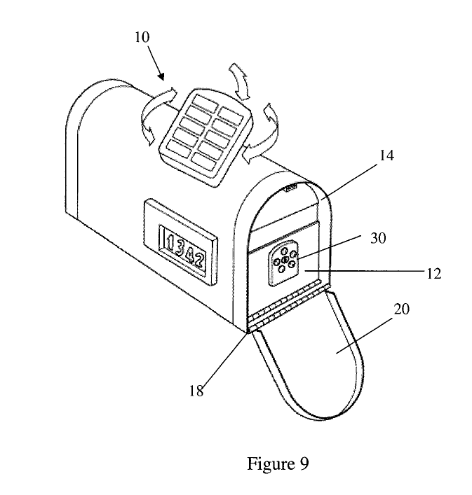

In another embodiment, shown in FIG. 8, the mailbox 10 may include an identification panel 32, indicating a house address, name, and/or number. The identification panel 32 may be positioned in any number of places on the exterior of the mailbox 10. For example, as shown in FIG. 8, the identification panel 32 may be arranged on a side portion 26 of the mailbox 10. Alternatively, the identification panel 32 may be arranged on the top portion of the mailbox 10. One or more light sources 28 may be arranged to provide light to the identification panel 32 allowing easy recognition in darkness. A side portion 26 of the mailbox 10 may include a semi-transparent or translucent material such as acrylic, polycarbonate, another plastic or glass to allow the light from the first light source to illuminate the identification panel.

In an embodiment herein, the mailbox includes an identification panel which is illuminated by the first light source. In an embodiment herein, the identification panel is integral with the mailbox and the first light source provides backlighting to the identification panel. Without intending to be limited by theory, it is believed that such an arrangement allows efficient use of the internal lighting to illuminate the identification panel for no additional energy cost.

In an embodiment herein the mailbox contains a hole through which light from the first light source shines, and the identification panel is at least partially transparent or at least partially opaque. This allows the same light source (e.g., the first light source) to light the interior of the mailbox while simultaneously illuminating, preferably backlighting, the identification panel, 32.

A single light source 28, such as the first light source, may be used to light the inside of the mailbox 10 and to back light the identification panel 32. Alternatively, two or more light sources may be used to light the inside of the mailbox 10 and the identification panel 32 separately. In an alternative embodiment shown in FIG. 8, one or more additional second light sources may be disposed on the exterior of the mailbox 10 so as to provide additional lighting, for example, front or down lighting, to the identification panel 32, and/or surrounding areas. The second light source(s) 28 is (are) typically powered from the rechargeable battery, but may also be powered from alternate sources, such as a separate battery, a electrical line, etc. Since the photocell only blocks power to the light sources when in sunlight, the rechargeable battery will power the first light source, and/or second light sources during darkness and not during daylight or other times when the first light source is not needed.

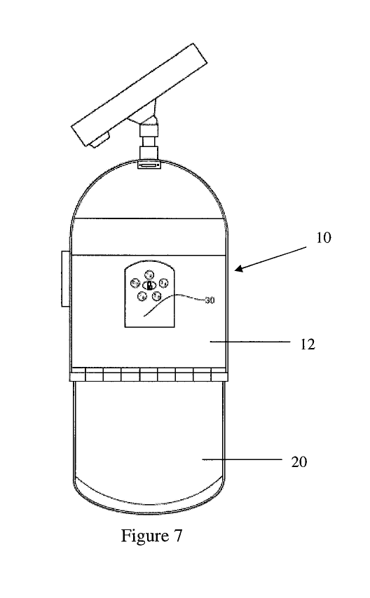

A further embodiment is shown in FIGS. 7 and 9. The mailbox 10 includes a lock 30 for securing the door in a closed position. This lock may provide a secure compartment within the mailbox 10. Such a secure compartment is especially desirable to prevent theft of the mailbox contents, to fight identity fraud, etc. The lock 30 includes an interior door 12 arranged behind the hinged door and, as shown in FIG. 9. In an embodiment herein the lock contains an electronic lock. The electronic lock may be powered by the rechargeable battery and/or a separate battery. In FIGS. 7 and 9, the lock 30 includes a keypad which may be mounted on the interior door 12. The keypad is powered by the rechargeable battery and/or a separate battery. In an embodiment herein, the separate battery is a replaceable battery. In an embodiment herein the electronic lock, the keypad, or both further contains an auxiliary energy input which may be used to power the electronic lock and/or the keypad if the rechargeable battery and/or the separate battery is dead or the circuits are inoperable. Such a auxiliary energy input is commonly available and present in, for example self-contained house safes with electronic locks.

When the user, either standing next to the mailbox, or leaning towards the mailbox from, for example, a car, enters the proper code on the keypad, the interior door 12 opens to reveal the contents of the secure compartment.

Alternatively, the electronic lock may employ a key fob (not shown), such as is commonly used to remotely lock or unlock cars, and/or a near field communication (NFC) system (not shown). With a key fob system, the lock would be an electronic lock powered by the rechargeable battery and/or a separate battery and the key fob would be powered by a separate battery. The battery in the key fob is typically removable and may be either rechargeable or disposable. Typically a NFC system, such as is present in some hotel doors and card keys, does not require a separate power source on the key itself.

It will be appreciated that the mailbox may include a manual override to the lock requiring power from the rechargeable batteries. The manual override may be a lock and key mechanism, or may be electronic.

Although the invention has been described with reference to specific examples, persons skilled in the art will appreciate that the invention can be embodied in many other forms.

We claim:

1. A mailbox comprising:
A. an interior cavity comprising an open front, a closed back opposite the open front;
B. a hinged and moveable door to cover the open front;
C. an exterior surface opposite the interior cavity, the exterior surface comprising an exterior panel;
D. a rechargeable battery;
E. a solar panel disposed on the mailbox, the solar panel arranged to generate electrical energy for recharging the rechargeable battery, the solar panel operatively connected to the rechargeable battery to form a circuit;
F. a first light source disposed within the interior cavity of the mailbox, the first light source being operatively connected to the rechargeable battery, the first light source being powered by the rechargeable battery; and
G. a photocell disposed on the exterior panel of the mailbox, wherein the photocell is configured to block power to the first light source when the photocell is illuminated so that the first light source only provides light when the photocell is not illuminated.

2. The mailbox of claim 1, wherein the solar panel is disposed on a top portion of the mailbox.

3. The mailbox of claim 1, wherein the solar panel is rotatably connected to the mailbox so that a user may selectively position the solar panel.

4. The mailbox of claim 1 further comprising a lock to secure the door in a closed position.

5. The mailbox of claim 4, wherein the lock comprises a keypad powered by the rechargeable battery or a separate replaceable battery.

6. The mailbox of claim 4, wherein the lock comprises an electronic lock powered by the rechargeable battery, and wherein the electronic lock is controlled by a key fob, and wherein the key fob is powered by a separate battery.

7. The mailbox of claim 4, wherein the lock comprises a near field communication system.

8. The mailbox of claim 1, further comprising an identification panel

9. The mailbox of claim 8, wherein the identification panel is illuminated by the first light source.

10. The mailbox of claim 8, wherein the identification panel is integral with the mailbox and wherein the first light source provides backlighting to the identification panel.

11. The mailbox of claim 8, further comprising a second light source configured to provide additional lighting to the identification panel.

12. The mailbox of claim 1, further comprising at least one accessory power socket in connected relation to the rechargeable battery for powering additional add-on electric accessories.

13. The mailbox of claim 1, wherein the first light source comprises a LED.

14. The mailbox of claim 1, wherein the first light source comprises an electroluminescent light source.

15. The mailbox of claim 1, wherein the first light source provides less than 1200 lumens.

16. The mailbox of claim 1, wherein the first light source provides less than 13,000 lux.

17. A mailbox comprising:
A. an interior cavity comprising an open front, a closed back opposite the open front;
B. a hinged and moveable door to cover the open front;
C. an exterior surface opposite the interior cavity, the exterior surface comprising an exterior panel;
D. a rechargeable battery;
E. a solar panel disposed on the mailbox, the solar panel arranged to generate electrical energy for recharging the rechargeable battery, the solar panel operatively connected to the rechargeable battery to form a circuit, and the solar panel rotatably connected to the mailbox;
F. a first light source disposed within the interior cavity of the mailbox, the first light source being operatively connected to the rechargeable battery, the first light source being powered by the rechargeable battery;
G. a photocell disposed on the exterior panel of the mailbox, wherein the photocell is configured to block power to the first light source when the photocell is illuminated so that the first light source only provides light when the photocell is not illuminated;
H. a lock to secure the door in a closed position, wherein the lock is an electronic lock powered by the rechargeable battery or a second replaceable battery; and
I. an identification panel, wherein the identification panel may be illuminated by the first light source.

18. The mailbox of claim 17, wherein the electronic lock is controlled by a key fob, and wherein the key fob is powered by a separate battery.

19. The mailbox of claim 17, wherein the rechargeable battery comprises a plurality of rechargeable batteries.

20. The mailbox of claim 17, wherein the first light source provides less than 1200 lumens.
